(19) United States
(12) Patent Application Publication
(10) Pub. No.: US 2026/0188713 A1
(43) Pub. Date: Jul. 2, 2026

(54) HYDROGEN FUEL CELL SYSTEM

(71) Applicant: Beijing IntelliUnity Technology Co., Ltd., Beijing (CN)

(72) Inventors: Jiantao XU, Beijing (CN); Changhong WEN, Beijing (CN); Zhixin WANG, Beijing (CN); Ji ZHANG, Beijing (CN)

(21) Appl. No.: 19/433,151

(22) Filed: Dec. 26, 2025

(30) Foreign Application Priority Data
Dec. 27, 2024 (CN) 2024119465536

(51) Int. Cl. H01M 8/04746; H01M 8/04082; H01M 8/04089

(52) U.S. Cl. CPC H01M 8/04753; H01M 8/04089; H01M 8/04201

(57) ABSTRACT

This disclosure relates to a hydrogen fuel cell system, including: a stack assembly, an air guide device and a hydrogen storage cylinder; The stack assembly has an air inlet and an air outlet. The air guide device includes an air hood, a fan and a mounting shell set inside the air hood. The air hood is set at the air outlet. A first air duct is formed between the outer wall of the mounting shell and the inner wall of the air hood. The air inlet of the fan is connected to the first air duct. A second air duct is set inside the mounting shell, and the hydrogen storage cylinder is set inside the second air duct.

### TECHNICAL FIELD

The disclosure relates to the technical field of power batteries, particularly to a hydrogen fuel cell system.

### BACKGROUND

Against the backdrop of the continuous enhancement of environmental awareness and the global energy transition, electric bicycles, as representatives of green travel, have significant importance in their research and development as well as promotion. At present, the electric bicycle market mainly relies on lead-acid batteries and lithium batteries as power sources. Hydrogen fuel cells, as innovative and pollution-free energy storage devices, directly generate electricity through the chemical reaction between hydrogen and oxygen. They have advantages such as high efficiency, environmental friendliness, and rapid refueling, providing a new development direction for the power system of electric bicycles.

Although hydrogen fuel cells have many advantages, the hydrogen fuel cells in related technologies still have the problem of low utilization efficiency of hydrogen.

### SUMMARY

In order to address or partially solve the problems existing in the related technologies, the present disclosure provides a hydrogen fuel cell system that can improve the utilization efficiency of hydrogen.

The present disclosure provides a hydrogen fuel cell system, including: a stack assembly, an air guide device and a hydrogen storage cylinder;

The stack assembly has an air inlet and an air outlet.

The air guide device comprises an air hood, a fan and a mounting shell arranged inside the air hood. The air hood is arranged at the air outlet. A first air duct is formed between the outer wall of the mounting shell and the inner wall of the air hood. The air inlet of the fan is in communication with the first air duct. A second air duct is provided inside the mounting shell. The mounting shell is provided with an inlet port and an outlet port respectively connected to the second air duct. The air outlet of the fan is connected to the inlet port, and the outlet port is connected to the outside of the air hood. The hydrogen storage cylinder is arranged inside the second air duct.

The airflow flowing out of the air outlet can be sent into the second air duct by the fan after entering the first air duct.

Further, the mounting shell has a relatively arranged first end and a second end, the inlet port is located at the first end, the outlet port is located at the second end, the first end is located inside the air hood, and the second end is connected to the side wall of the air hood.

The mounting shell and the air outlet both extend laterally, and the mounting shell is arranged opposite to the air outlet.

Further, there is a first clearance between the outer side wall of the mounting shell and the inner side wall of the air hood, so that the airflow flowing out of the air outlet can flow from the mounting shell towards the side of the air outlet to the side of the mounting shell away from the air outlet.

Further, the fan is located at the air inlet, the air inlet of the fan is located in the first air duct, and the air inlet of the fan is oriented towards the side away from the air inlet.

Furthermore, the outer side wall of the mounting shell is of an arc-shaped structure; and/or, the mounting shell is of a hollow cylindrical shape.

Furthermore, there is a second clearance between the outer side wall of the hydrogen storage cylinder and the inner side wall of the mounting shell for the flow of gas supply.

Further, the inner side wall of the mounting shell is provided with multiple support ribs extending along the axial direction of the hydrogen storage cylinder, and the multiple support ribs are arranged circumferentially at intervals.

Further, the mounting shell and the air hood are of an integrally formed structure; and/or, one side of the air hood is provided with an installation slot, and the fan is arranged in the installation slot.

Furthermore, the stack assembly is also provided with a hydrogen inlet, which is in communication with the hydrogen storage cylinder.

Furthermore, the above-mentioned hydrogen fuel cell system also includes: a controller, the controller is electrically connected to the fan.

The technical solution provided in this disclosure may include the following beneficial effects: The gas heated by the reaction of the stack assembly flows into the first air duct from the outlet. Then, the gas in the first air duct is sent into the second air duct by the fan and discharged from the outlet port. On the one hand, this can carry away the heat generated by the stack assembly during operation and ensure its stable operation. On the other hand, it can use the heat generated by the stack assembly to heat the hydrogen storage cylinder. When gas flows in the first and second air ducts, heat exchange occurs, transferring heat to the hydrogen storage cylinders in the second air duct, achieving heat recovery and utilization. This not only enhances the utilization efficiency of hydrogen but also significantly reduces the overall energy consumption of the system, realizing efficient energy utilization and thereby improving the power generation efficiency and thermal management performance of the hydrogen fuel cell system.

It should be understood that the general description above and the detailed description following are only illustrative and explanatory in nature and do not limit this disclosure

### BRIEF DESCRIPTION OF THE DRAWINGS

By referring to the attached drawings for a more detailed description of the exemplary embodiments of the present disclosure, the above-mentioned and other purposes, features and advantages of the present disclosure will become more obvious, among which, in the exemplary embodiments of the present disclosure, the same reference number usually represents the same component.

FIG. 1 is a structural schematic diagram of the hydrogen fuel cell system shown in an embodiment of the present disclosure;

FIG. 2 is another structural schematic diagram of the hydrogen fuel cell system shown in an embodiment of the present disclosure;

FIG. 3 is a main view schematic diagram of the hydrogen fuel cell system shown in an embodiment of the present disclosure;

FIG. 4 is a top view schematic diagram of the hydrogen fuel cell system shown in FIG. 3.

FIG. 5 is A sectional view of FIG. 4 along the A-A section line;

FIG. 6 is a sectional view of FIG. 4 along the B-B section line.

Attached figure markings: stack assembly 1, air inlet 11, air outlet 12, membrane electrode assembly 13, shell 14, air guide device 2, air hood 21, installation slot 211, fan 22, mounting shell 23, inlet port 231, outlet port 232, first end 233, second end 234, support rib 235, hydrogen storage cylinder 3, first air duct 4, second air duct 5, first clearance 6, second clearance 7.

### DETAILED DESCRIPTION OF THE EMBODIMENTS

The following will describe in more detail the implementation mode of this disclosure with reference to the attached drawings. Although the attached figures show the embodiments of the present disclosure, it should be understood that the present disclosure can be realized in various forms and should not be limited by the embodiments described here. On the contrary, these implementation methods are provided to make the present disclosure more thorough and complete, and to be able to convey the scope of the present disclosure in its entirety to those skilled in the art.

It should be understood that although terms such as "first", "second", "third", etc. may be used in this disclosure to describe various information, such information should not be limited to these terms. These terms are only used to distinguish the same type of information from each other. For example, within the scope of this disclosure, the first information may also be referred to as the second information, and similarly, the second information may also be referred to as the first information. Thus, a feature that is defined as "first" or "second" can explicitly or implicitly include one or more of such features. In the description of this disclosure, "multiple" means two or more, unless otherwise explicitly and specifically limited.

In the description of this disclosure, it should be understood that the terms "length", "width", "up", "down", "front", "back", "left", "right", "vertical", "horizontal", "top", "bottom", "inside", "outside", etc. indicate positions or positional relationships based on the positions or positional relationships shown in the attached drawings. It is only for the convenience of describing the present disclosure and simplifying the description, and does not indicate or imply that the device or component referred to must have a specific orientation, be constructed and operated in a specific orientation, and therefore should not be construed as a limitation of the present disclosure.

Unless otherwise clearly stipulated and limited, terms such as "installation", "connection", "connection", and "fixation" should be understood in a broad sense. For example, they can be fixed connections, detachable connections, or integrated as a whole. It can be a mechanical connection or an electrical connection. It can be directly connected, or indirectly connected through an intermediate medium. It can be the internal connection of two components or the interaction relationship between two components. For those skilled in the art, they can understand the specific meanings of the above terms in this disclosure according to the specific circumstances.

The following is a detailed description of the technical solution of the embodiments of the present disclosure in combination with the attached drawings.

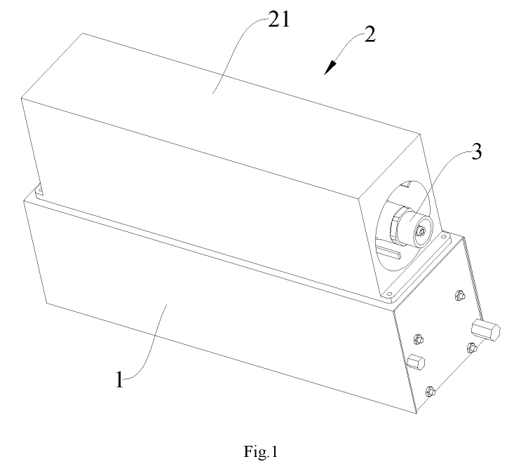

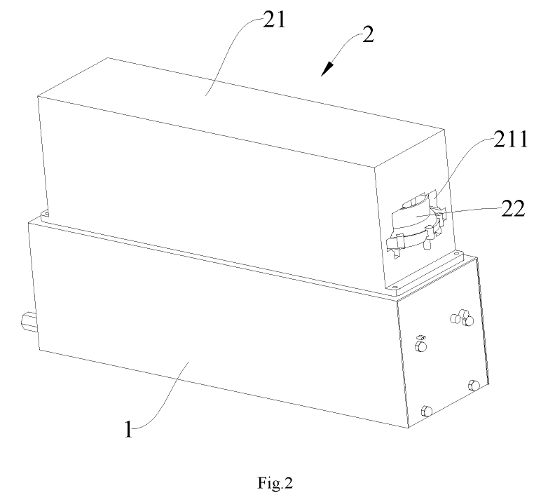

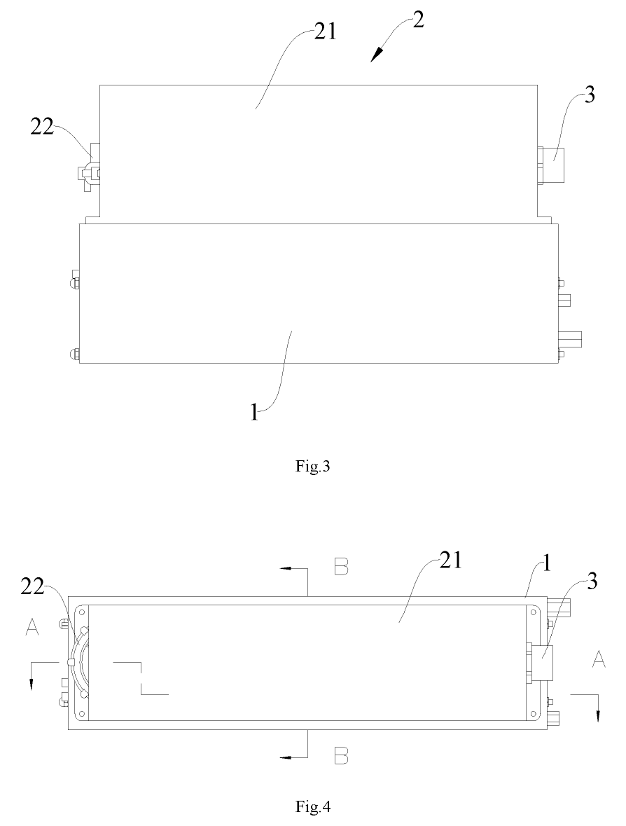

As shown in FIG. 1 to FIG. 6 , the embodiments of the present disclosure provide a hydrogen fuel cell system, including a stack assembly 1, an air guide device 2 and a hydrogen storage cylinder 3.

The stack assembly 1 has an air inlet 11 and an air outlet 12. Inside the stack assembly 1, there is a membrane electrode assembly 13, which is used to convert hydrogen and oxygen into electrical energy through electrochemical reactions. The existing conventional membrane electrode assembly 13 can be adopted in the embodiments of the present disclosure. Air enters the stack assembly 1 through the air inlet 11 to provide the oxygen required for the reaction of the membrane electrode assembly 13. After passing through the membrane electrode assembly 13, the gas is discharged from the stack assembly 1 through the air outlet 12. Among them, the stack assembly 1 has a shell 14, the membrane electrode assembly 13 is located inside the shell 14, the air inlet 11 and the air outlet 12 are set on opposite sides of the shell 14, and the membrane electrode assembly 13 is located between the air inlet 11 and the air outlet 12.

The air guide device 2 comprises an air hood 21, a fan 22 and a mounting shell 23 set inside the air hood 21. The air hood 21 is set at the air outlet 12. The outer wall of the mounting shell 23 and the inner wall of the air hood 21 form a first air duct 4. The gas discharged from the air outlet 12 enters the first air duct 4. The air inlet of the fan 22 is connected to the first air duct 4. The mounting shell 23 is equipped with a second air duct 5. The mounting shell 23 is provided with an inlet port 231 and an outlet port 232, which are respectively connected to the second air duct 5. The air outlet of the fan 22 is connected to the inlet port 231, and the outlet port 232 is connected to the outside of the air hood 21. The hydrogen storage cylinder 3 is located inside the second air duct 5.

The airflow flowing out of the air outlet 12 enters the first air duct 4 and can be sent into the second air duct 5 by the fan 22. After passing through the second air duct 5, the gas is discharged from the outlet port 232 to the outside of the air hood 21.

The gas heated by the reaction of the stack assembly 1 flows into the first air duct 4 from air outlet 12, and then is sent into the second air duct 5 by the fan 22. Finally, it is discharged from the outlet port 232. On the one hand, this can remove the heat generated by the stack assembly 1 during operation and ensure the stable operation of the stack assembly 1 On the other hand, the heat generated by the stack assembly 1 can be utilized to heat the hydrogen storage cylinder 3. When the gas flows through the first air duct 4 and the second air duct 5, heat exchange occurs, thereby transferring the heat to the hydrogen storage cylinder 3 within the second air duct 5, achieving heat recovery and utilization. This not only enhances the utilization efficiency of hydrogen but also significantly reduces the overall energy consumption of the system, realizing efficient energy utilization. This has thereby enhanced the power generation efficiency and thermal management performance of the hydrogen fuel cell system.

Specifically, when the gas passes through the first air duct 4, it can transfer heat to the mounting shell 23. After being heated, the mounting shell 23 can transfer heat to the hydrogen storage cylinder 3 inside it. When the gas passes through the second air duct 5, it will come into contact with the outer wall of the hydrogen storage cylinder 3, thereby transferring heat to the hydrogen storage cylinder 3 again. In a hydrogen fuel cell system, heating the temperature of the hydrogen storage cylinder 3 has multiple functions such as enhancing hydrogen transmission efficiency, optimizing reaction kinetics, and ensuring system stability. In this disclosure embodiment, the heat generated by the reaction in stack assembly 1 is used to heat the hydrogen storage cylinder 3, thereby reducing the need for additional heating devices, improving hydrogen utilization efficiency, and lowering the overall energy consumption of the system.

In some embodiments, the fan 22 may adopt a vortex fan. Fan 22 can generate high-pressure air flow. This air flow not only provides the necessary oxygen for the reaction of stack assembly 1, but also effectively carries away the heat generated by stack assembly 1 during operation, ensuring the stable operation of stack assembly 1, maintaining its power output, and helping to keep stack assembly 1 within the optimal working temperature range to prevent overheating. Extend the service life of stack assembly 1. By controlling the power of fan 22, the intake air volume of stack assembly 1 can be controlled, enhancing the dynamic response capability of stack assembly 1. This enables the fuel cell to quickly adjust under different working loads, further reducing energy consumption and improving the overall performance of the system.

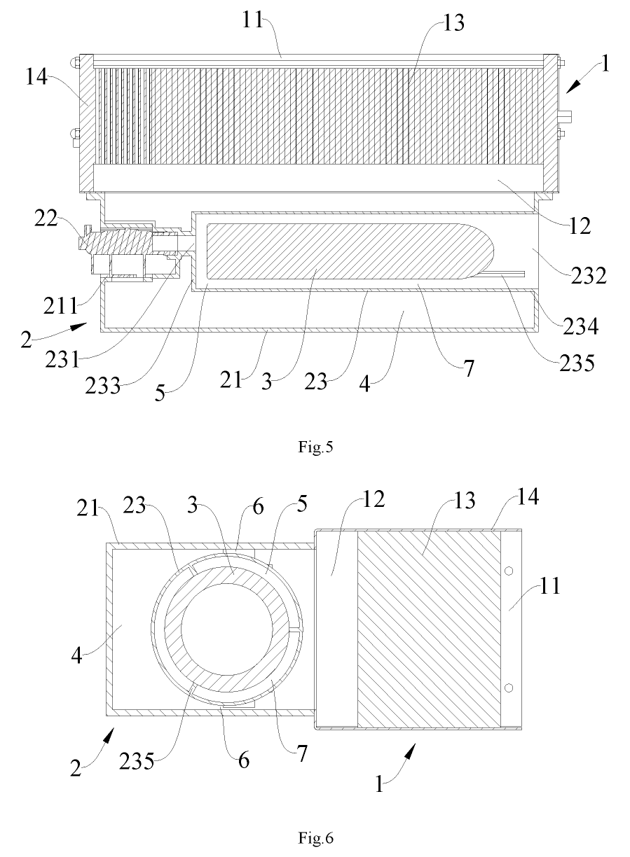

In some embodiments, as shown in FIG. 5, the mounting shell 23 has a relatively arranged first end 233 and a second end 234. The inlet port 231 is located at the first end 233, the outlet port 232 is located at the second end 234, the first end 233 is located inside the air hood 21, and the second end 234 is connected to the side wall of the air hood 21. Both the mounting shell 23 and the air outlet 12 extend laterally. The mounting shell 23 is arranged opposite to the air outlet 12.

In this way, the gas discharged from the air outlet 12 can have a larger contact area with the mounting shell 23 in the transverse direction, improving the heat exchange performance between the airflow and the outer wall of the mounting shell 23.

Specifically, the second end 234 is fixedly connected to the side wall of the air hood 21. The outlet port 232 forms an opening on the side wall of the air hood 21. When disassembling and assembling the hydrogen storage cylinder 3, it can be placed into the mounting shell 23 through the outlet port 232 or removed from the mounting shell 23. The diameter of the outlet port 232 is larger than the outer diameter of the hydrogen storage cylinder 3. hydrogen storage cylinder 3 is also arranged horizontally and can be coaxially set with the second air duct 5. The bottle body of hydrogen storage cylinder 3 is basically completely located within the second air duct 5.

In some embodiments, as shown in FIG. 6, there is a first clearance 6 between the outer side wall of the mounting shell 23 and the inner side wall of the air hood 21, so that the airflow flowing out of the air outlet 12 can flow from the side of the mounting shell 23 facing the air outlet 12 to the side of the mounting shell 23 away from the air outlet 12.

Specifically, please refer to FIG. 6. In the figure, the air outlet 12 is located on the right side of the mounting shell 23. There is a first clearance 6 between the outer side wall of the mounting shell 23 and the upper and lower inner side walls of the air hood 21. The gas flows from the air outlet 12 to the left towards the mounting shell 23. When it reaches the mounting shell 23, it continues to move along the outer side wall of the mounting shell 23. And it can move to the left side of the mounting shell 23 through the first clearance 6, which can effectively guide the airflow and ensure that the gas is more evenly distributed on the mounting shell 23, thereby improving the heat exchange performance. Meanwhile, this structure can effectively guide the airflow, ensuring that oxygen is evenly distributed to all parts of the fuel cell, thereby enhancing the utilization rate of oxygen and the cooling efficiency of the battery.

In some embodiments, as shown in FIG. 5, the fan 22 is located at the inlet port 231, the air inlet of the fan 22 is within the first air duct 4, and the air inlet of the fan 22 faces the side away from the air inlet 11. Specifically, in the illustration, the air outlet 12 is located below the mounting shell 23. The gas flowing out of the air outlet 12 moves upward and moves from the first clearance 6 on both sides of the mounting shell 23 to the upper side of the mounting shell 23, and then moves left until it enters the air inlet of the fan 22 with the opening facing upwards. Then, fan 22 draws the gas from the inlet port 231 into the second air duct 5 and moves it to the right until it is discharged from the outlet port 232. This can provide a longer gas flow path within a limited space, which is very important for hydrogen fuel cell systems that need to achieve gas heat dissipation, heating of hydrogen storage cylinder 3 and uniform gas distribution in a smaller volume, and is conducive to the miniaturization of fuel cell systems.

In some embodiments, the fan 22 can also be set at other positions, for example, on the side wall of the air hood 21 facing away from the air inlet 11, that is, at the lower end of the air hood 21 as shown in FIG. 5, and the air outlet of the fan 22 can be connected to the inlet port 231 through a pipeline.

In some embodiments, the outer side wall of the mounting shell 23 is of an arc-shaped structure, which enables the gas to move arc-shaped along the outer side wall of the mounting shell 23. This shape can reduce the turbulence and vortices of the airflow, making the airflow more stable and helping to reduce the pressure loss of the airflow in the air duct. This is because the flow of the fluid in the curve is relatively stable. Reducing energy loss caused by turbulence can help better manage the temperature of the airflow and improve cooling efficiency.

In some embodiments, as shown in FIG. 6, the mounting shell 23 is in the shape of a hollow cylinder, and the inner cavity of the mounting shell 23 is the second air duct 5.

In some embodiments, as shown in FIG. 5 and FIG. 6, there is a second clearance 7 between the outer side wall of the hydrogen storage cylinder 3 and the inner side wall of the mounting shell 23 for the flow of gas supply. When the gas flows in the second channel, it flows along the second clearance 7, thereby transferring heat to the outer side wall of the hydrogen storage cylinder 3 to heat it.

In some embodiments, the inner side wall of the mounting shell 23 is provided with multiple support ribs 235 extending along the axial direction of the hydrogen storage cylinder 3, and the multiple support ribs 235 are arranged circumferentially at intervals. Support rib 235 is used to support the hydrogen storage cylinder 3 and create a clearance between the outer side wall of the hydrogen storage cylinder 3 and the inner side wall of the mounting shell 23, thereby forming a second clearance 7.

In some embodiments, the mounting shell 23 and the air hood 21 are integrally molded structures. Specifically, the mounting shell 23 and the air hood 21 are formed by plastic injection molding.

In some embodiments, one side of the air hood 21 is provided with an installation slot 211, and the fan 22 is arranged in the installation slot 211. The fan 22 can be installed on the air hood 21 through the installation slot 211, and part of the fan 22 can extend out of the installation slot 211, facilitating the removal and placement of the fan 22 from the installation slot 211.

In some embodiments, stack assembly 1 is also provided with a hydrogen inlet, which is connected to a hydrogen storage cylinder 3, and the hydrogen storage cylinder 3 supplies hydrogen to stack assembly 1 through the hydrogen inlet.

In some embodiments, the hydrogen fuel cell system can increase the voltage by increasing the number of cells in the membrane electrode assembly 13, accelerate the reaction rate by reducing the width of the plates, and decrease the overall volume by reducing the thickness of the plates, thereby enhancing the energy density, reaction rate, and reducing the overall volume to meet the demands of modern energy equipment for high performance and miniaturization.

Increasing the number of battery cells (single cells) in the stack can directly raise the output voltage of the entire stack. This is because each battery cell generates a certain voltage, and when the cells are connected in series, the voltages add up. Higher voltage can reduce current demand, thereby lowering transmission loss and enhancing the overall efficiency of the system. Reducing the width of the plates can decrease the distance that electrons travel on them, thereby lowering resistance and accelerating the speed of electron transmission. Reducing the thickness of the plates can significantly lower the overall volume of stack assembly 1, which is particularly important for portable devices and space-constrained applications.

In some embodiments, the hydrogen fuel cell system also includes a controller, which is electrically connected to the fan 22. The controller is used to control the output power of the fan 22, thereby controlling the air flow entering the stack assembly 1.

The hydrogen fuel cell system of the embodiments of the present disclosure can be used in electric vehicles. Among them, the controller can also be connected to the speed control component of the electric vehicle. The speed control component can be a hand-turned or foot-operated switch, and the user can control the driving speed through the speed control component. The controller can receive signals from the speed control component and control the output power of fan 22 based on the signals from the speed control component. For instance, when a user accelerates through the speed control component, the controller increases the output power of fan 22 based on the acceleration signal, thereby enhancing the intake flow at the air inlet 11 and achieving a transient response. Among them, electric vehicles can be two-wheeled, three-wheeled or four-wheeled electric vehicles, etc.

The scheme of this disclosure has been described in detail with reference to the attached drawings in the previous text. In the above embodiments, the descriptions of each embodiment have their own focuses. For the parts not described in detail in a certain embodiment, please refer to the relevant descriptions of other embodiments. Those skilled in the art should also be aware that the actions and modules involved in the specification are not necessarily necessary for the present disclosure. In addition, it can be understood that the steps in the method of the embodiment of the present disclosure can be adjusted in sequence, merged and deleted as needed, and the modules in the device of the embodiment of the present disclosure can be merged, divided and deleted as needed.

The above has described the various embodiments of the present disclosure. The above description is exemplary, not exhaustive, and is not limited to the disclosed embodiments. Without deviating from the scope and spirit of the various embodiments described, many modifications and changes are obvious to those skilled in the art. The selection of terms used in this article is intended to best explain the principles, practical applications or improvements to the technology in the market of each embodiment, or to enable other ordinary technicians in the art to understand the embodiments disclosed herein.

What is claimed is:

1. A hydrogen fuel cell system, comprising a stack assembly, an air guide device, and a hydrogen storage cylinder;
wherein the stack assembly has an air inlet and an air outlet;
the air guide device comprises an air hood, a fan, and a mounting shell arranged inside the air hood; the air hood is arranged at the air outlet; a first air duct is formed between the outer wall of the mounting shell and the inner wall of the air hood; the air inlet of the fan is in communication with the first air duct; a second air duct is provided inside the mounting shell; the mounting shell is provided with an inlet port and an outlet port respectively connected to the second air duct; the air outlet of the fan is connected to the inlet port, and the outlet port is connected to the outside of the air hood; the hydrogen storage cylinder is arranged inside the second air duct;
the airflow flowing out of the air outlet is sent into the second air duct by the fan after entering the first air duct.

2. The hydrogen fuel cell system according to claim 1, wherein the mounting shell has a relatively arranged a first end and a second end, the inlet port is located at the first end, the outlet port is located at the second end, the first end is located in the air hood, and the second end is connected to the side wall of the air hood;
The mounting shell and the air outlet both extend laterally, and the mounting shell is arranged opposite to the air outlet.

3. The hydrogen fuel cell system according to claim 1, wherein a first clearance is defined between the outer side wall of the mounting shell and the inner side wall of the air hood, so that the airflow flowing out of the outlet can flow from the mounting shell towards the side of the outlet to the side of the mounting shell away from the outlet.

4. The hydrogen fuel cell system according to claim 3, wherein the fan is located at the air inlet, the air inlet of the fan is located in the first air duct, and the air inlet of the fan is oriented towards the side away from the air inlet.

5. The hydrogen fuel cell system according to claim 3, wherein the outer side wall of the mounting shell is of an arc-shaped structure; and/or, the mounting shell is of a hollow cylindrical shape.

6. The hydrogen fuel cell system according to claim 1, wherein a second clearance for the flow of gas supply is defined between the outer side wall of the hydrogen storage cylinder and the inner side wall of the mounting shell.

7. The hydrogen fuel cell system according to claim 6, wherein the inner side wall of the mounting shell is provided with multiple support ribs extending along the axial direction of the hydrogen storage cylinder, and the multiple support ribs are arranged circumferentially at intervals.

8. The hydrogen fuel cell system according to claim 1, wherein the mounting shell and the air hood are of an integrally formed structure; and/or, one side of the air hood is provided with an installation slot, and the fan is arranged in the installation slot.

9. The hydrogen fuel cell system according to claim 1, wherein the stack assembly is further provided with a hydrogen inlet, and the hydrogen inlet is in communication with the hydrogen storage cylinder.

10. The hydrogen fuel cell system according to claim 1, further comprising a controller, wherein the controller is electrically connected to the fan.
